(19) United States
(12) Patent Application Publication
(10) Pub. No.: US 2007/0096940 A1
(43) Pub. Date: May 3, 2007

(54) System and method for identifying and configuring wireless remote controls for keyless entry systems

(76) Inventors: Michael Penano Laranang, Georgetown, TX (US); Ricardo Sevilla Lopez, Round Rock, TX (US); Francisco Sevilla Lopez, Round Rock, TX (US); Richard Penano Laranang, Round Rock, TX (US); Emmanuel Enrique Lopez, Georgetown, TX (US); Sam Neang, Round Rock, TX (US)

Correspondence Address: FISH & RICHARDSON P.C., P.O BOX 1022, Minneapolis, MN, 55440-1022, US

(21) Appl. No.: 11/263,121

(22) Filed: Oct. 31, 2005

(51) Int. Cl. G05B 19/02; G08C 19/00

(52) U.S. Cl. 340/825.72; 340/825.22

(57) ABSTRACT

The invention provides improved remote control replacement capability for keyless entry systems. A preferred embodiment provides a software program allowing a user to input various criteria, such as vehicle make, model, and year, vehicle identification number (VIN), remote control part number, receiver information, and so forth. Based on such information, the program queries a code database that relates this identifying information to the correct code format for the replacement remote control. The program communicates with a remote control programmer (RCP) and indicates the code format to be used for the replacement remote control, based on the query to the code database. A formatted code is programmed into the replacement remote control. Previously programmed codes may be retrieved. In one embodiment, a duplication mode allows the RCP to auto-sense and select the correct code type during the duplication process.

### TECHNICAL FIELD OF THE INVENTION

This invention relates generally to wireless remote controls for keyless entry systems used to lock and unlock vehicle doors, or open and close building doors, and more particularly to a system and method for provisioning and configuring replacement wireless remote controls for such keyless entry systems.

### BACKGROUND OF THE INVENTION

Wireless remote controls are commonly used to provide keyless entry to vehicles, such as locking/unlocking or opening/closing the vehicle's doors, or in the case of buildings, opening/closing doors. A wireless remote control has a radio frequency (RF) or infrared (IR) transmitter, which communicates with a receiver in the keyless entry system. The remote control is matched to a specific keyless entry system receiver in at least two respects. First, each receiver is matched to a specific model of remote control that is designed to work with that particular keyless entry system. The transmitter in the remote control must be compatible with the receiver in the keyless entry system in terms of frequency (for RF-based remotes), wavelength (for IR remotes), pulse repetition frequency, coding scheme, and so on. Second, each receiver and its corresponding remote control are programmed with the same coded information to permit only the intended remote control to access the keyless entry system. Older remote controls use a fixed code for each function, i.e., the same code is transmitted by the remote control each time the user presses a particular button or key. Newer remote controls use rolling codes, in other words, the code for each function changes each time a particular button or key is pressed, and the transmitter and receiver are synchronized by a common algorithm.

There are several systems known in the art to replace a keyless entry system remote control that has been lost, stolen, or that is no longer functional. Each of the following commercial systems and methods of obtaining replacement a remote control suffers from several disadvantages, however, as detailed below.

A remote control can often be duplicated if a working original remote control is available. There are products on the market today that allow retailers to avoid high stocking requirements while still providing universal coverage. For example, universal remote duplicators (URDs) work by simply copying the code from a customer's working remote onto a URD. Unfortunately, URDs are not applicable in situations in which the customer does not have a working remote. Real-world experience has shown that approximately two out of three persons needing replacement remote controls do not have an existing functioning remote to be duplicated. Currently, the only solution in these cases is to stock the correct replacement remotes, or in the case of garage door openers, utilize a universal remote requiring manual manipulation of switches on the circuit board for proper code selection.

A remote control duplicator receives and stores the RF signal output by the original remote control as each of the remote's buttons are pressed, thus learning the corresponding fixed code for each remote function. This code reading is typically performed using a universal duplicating device in which the type of remote control code is not pre-specified. In this case, the duplicating device must determine all characteristics of the remote code, such as frequency, pulse repetition frequency, and code, from the received remote signal. The duplicating device synthesizes the remote code from these detected characteristics. This process results in an imperfect representation of the original remote code, and often results in delayed response time of remote functions from the duplicate remote relative to the original equipment source remote, a significant disadvantage. A further disadvantage of remote duplication is the need to have a functioning original remote control. Since a replacement remote control is usually needed due to loss of or damage to the original remote, remote duplication is not possible. Furthermore, fixed-code remote duplicators known in the art are not capable of on-demand remote control generation, that is, the identification and configuration of a new remote control based on criteria such as make, model, and year of the vehicle, or printed identifiers on the original remote such as manufacturer name, brand, model number, FCC identification number, circuit board labels, and so on.

An example of existing remote control duplicators is the Samisen Model DJ-CM2000 Transmitter Duplicator, which receives the RF signal from an existing working remote control, then writes the code over a five-wire connector onto a remote control blank (a remote control that has not yet been programmed with a code) using one of three code formats that must be selected by the user. The Samisen DJ-CM2000 does not have a communication port for communicating with an external device, such as a computer.

The Remocon RMC888 Duplicator also receives the RF signal from an existing working remote control, determines which of two code formats is appropriate, then writes the code onto a remote control blank over a six-wire connector. The Remocon RMC888 also lacks a communication port for communicating with external devices.

The Portman Mini Frequency Counter and Copier also receives the RF signal from an existing working remote control, then writes the code onto a remote control blank over a four-wire connector using a single, non-selectable code format. The Portman system also lacks a communication port for communicating with external devices.

The AllRemote CT2000E/CT2000SR Multi-Functional RF Remote Digital Analyser is similar to the Portman system in that it also receives the RF signal from an existing working remote control, then writes the code onto a remote control blank over a five-wire connector using a single, non-selectable code format. The AllRemote system also lacks a communication port for communicating with external devices.

The JMA, Alejandro Altuna, S. A., CTM-200 Remote Control Duplicator also receives the RF signal from an existing working remote control, then writes the code onto a remote control blank over a five-wire connector using a single, non-selectable code format. The JMA system also lacks a communication port for communicating with external devices.

The StingPro Learning Remote TX-44 is similar to the systems previously described, in that it also receives the RF signal from an existing working remote control, then writes the code onto a remote control blank using a single, non-selectable code format, but the StingPro system transfers the code to the remote blank wirelessly. The StingPro system also lacks a communication port for communicating with external devices.

Another example of a remote control replacement is the SkyLink Mode 39 Universal Garage Door Remote Control. Unlike remote control duplicators, all of which require an existing functional remote control in order to create a replacement remote control, with the SkyLink product the user selects one of eight code formats and the codes are manually set using DIP switches on the circuit board of the remote control, and therefore, a source remote control is not necessary. The disadvantages of this approach include the need to partly disassemble the remote control and make manual settings to the device, and the requirement to set the DIP switches correctly.

On-demand generation is yet another way to obtain a replacement remote control. This method requires the retailer or dealer to stock a wide selection of pre-coded replacement remotes to handle a large number of vehicle receiver types. The high inventory requirement is the primary barrier to mass retailing of replacement remotes. For example, a retailer must stock over 110 unique original equipment (OE) fixed-code remote controls to achieve total coverage of automobiles up to model year 1998 alone. At an average wholesale price of $50 per remote, total coverage through this model year requires an investment of approximately $5,000 for each retail location. As of 2005, there are approximately 450 unique OE remote controls, including fixed-code and rolling-code types, requiring an investment of over $20,000 for each retail location. Another shortcoming of existing techniques for on-demand generation of remote controls is the requirement to manually match the correct replacement remote and the subsequent programming procedure to enable use of the remote control with the customer's vehicle.

Therefore, a need exists for a system and method to identify and configure replacement remote controls for keyless entry systems in an efficient, cost-effective, and accurate manner.

### SUMMARY OF THE INVENTION

The present invention is directed to a system and method for provisioning replacement remote controls for keyless entry systems. The invention enables retailers and service providers (such as locksmiths) to generate replacement remote controls for the operation of automotive keyless entry systems and other access systems such as garage door openers. Unlike prior art methods, the invention does not require a customer to have an existing working remote for on-demand generation of new replacement keyless entry remotes, and further does not typically involve any manual manipulation of switches or settings on the replacement remote to set the correct codes.

The system of the present invention includes a software program executed on a computing device, a code database of remote control characteristics, and a remote control programmer (RCP), a device that generates replacement remote controls for operation of fixed-code keyless entry systems. In other words, the RCP “programs” or writes the code into a replacement remote control. This exemplary RCP is connected to a remote control “blank” (an unprogrammed remote control) with a 4-wire connector that serves as the interface between the read/write unit and the replacement remote control. In another embodiment, the RCP consists of a radio frequency (RF) read/write unit that interfaces with a computer through a serial connection. In this alternative embodiment, the RCP communicates with the remote control blank wirelessly. Source remote controls interface wirelessly with the read/write unit via the RF signals output by the source remote.

The software program of the invention allows a user to input various criteria, such as vehicle make, model, and year, vehicle identification number (VIN), remote control part number, receiver information, and so forth. In an alternative embodiment, the VIN is entered via barcode scanner rather than manually typing it in on a keyboard. Based on the information input to the program, the program queries a code database that relates this identifying information to the correct code format for the replacement remote control. The program communicates with the RCP and indicates the code format to be used for the replacement remote control, based on the query to the code database. Returning customers can provide customer name, address, telephone number or other customer identifier to retrieve the codes previously transferred onto their remote blank. In duplication mode, because the RCP auto-senses and selects the correct code type during the duplication process, the user does not manually enter the year, make, model, or VIN of the vehicle in the program, but can enter the customer information.

In one embodiment of the invention, the software program is installed and executed on the computer, but the code database and remote control programmer are separate components. The code database may be located on the same computer containing the software program or on another, separate computer. The computer containing the code database may be accessible over any type or number of networks, including, for example, the Internet. Likewise, the RCP can be connected directly to the computer containing the software program with an asynchronous serial connection, or over any type and number of networks, including, for example, the Internet.

In another embodiment of the invention, the computer, software program, code database, and RCP are all contained within one device, which can be stationary or portable. In this embodiment, the software program is accessed via a keyboard and/or pointing device or by using a barcode scanner.

In yet another embodiment of the invention, the computer, software program, code database and remote control programmer are housed within a kiosk to facilitate the duplication or origination of replacement remote controls in a turnkey, space-efficient form factor.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A shows a remote control origination system according to the preferred embodiment.

FIG. 1B shows a remote control duplication system according to the preferred embodiment.

FIG. 2 shows a software program used to input characteristics of a remote control used in remote control origination.

FIG. 3 shows a database schema for storing remote control configuration information according to the preferred embodiment.

FIG. 4 shows details of a read/write unit according to the preferred embodiment.

FIG. 5 shows details of a remote control blank according to the preferred embodiment.

FIG. 6 shows a flow chart of the method of generating a replacement remote control.

Like reference symbols in the various drawings indicate like elements.

### DETAILED DESCRIPTION OF THE PREFERRED EMBODIMENT

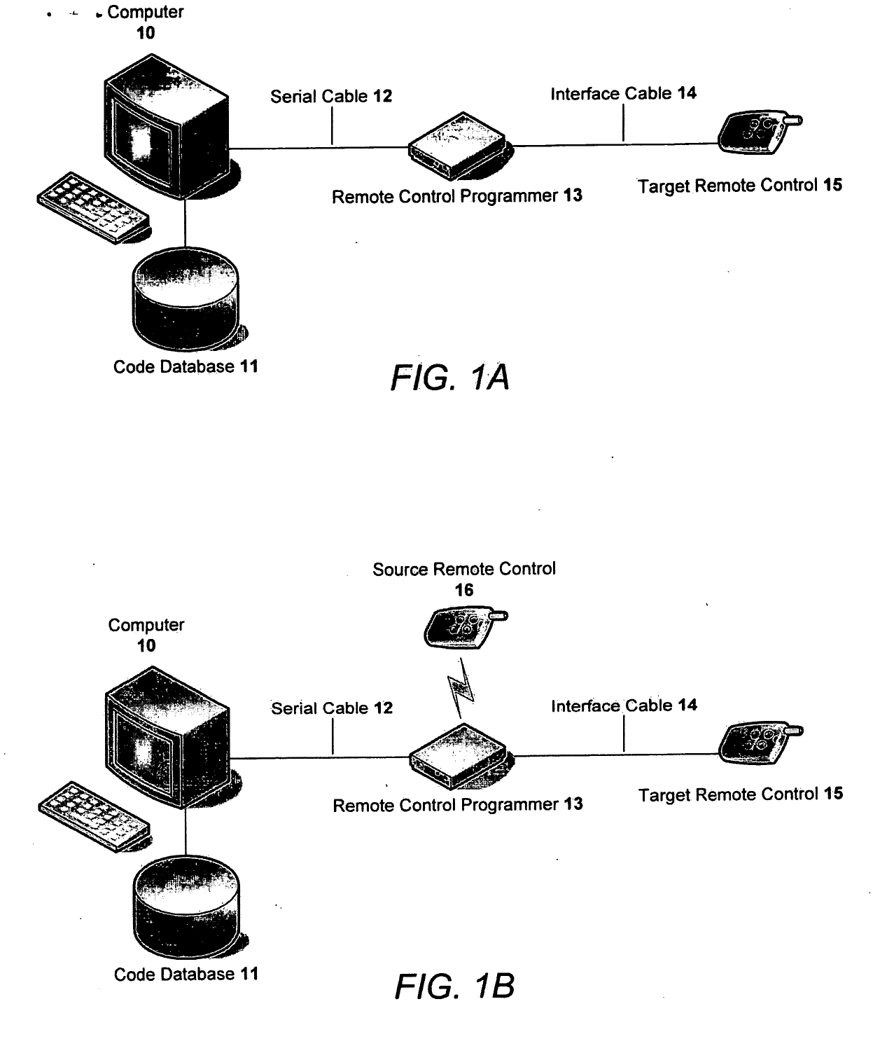

The preferred embodiment of the invention solves the problem of generating replacement remote controls in either duplication or on-demand generation modes. FIG. 1A shows a system capable of on-demand generation of remote controls, including a computer 10 (containing the software program), code database 11, remote control programmer 13, and the target remote control 15, according to a preferred embodiment of the present invention. As shown in this figure, computer 10 is connected to remote control programmer 13 by serial cable 12. In this configuration, computer 10 can communicate with remote control programmer 13 using any serial communication protocol, e.g., RS-232 or Universal Serial Bus (USB), and over any type of serial cable. In the embodiment depicted in FIG. 1A, remote control programmer 13 is connected to target remote control 15, the remote control to be programmed.

FIG. 1B shows a system according to the present invention that is capable of duplication of existing functional remote controls. In this embodiment, remote control programmer 13 communicates wirelessly with source remote control 16, the existing functional remote control to be duplicated.

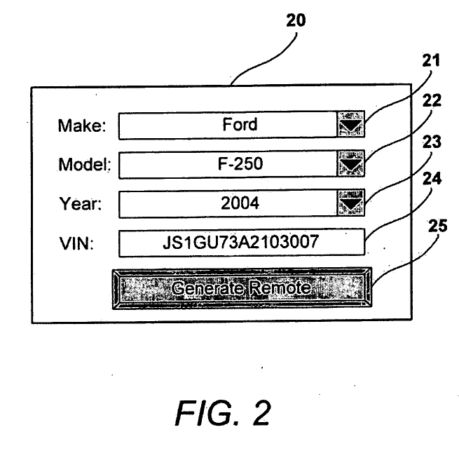

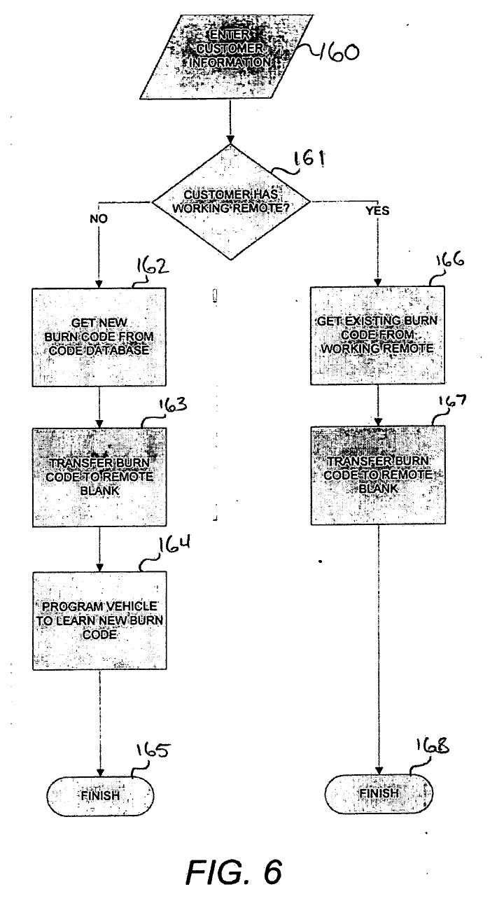

FIG. 2 shows an embodiment of the software program of the present invention, which is used in both duplication and on-demand generation modes. The depicted software interface 20 shows drop-down menus 21-23 for entering vehicle make, model, and year information. VIN information may be entered in field 24 by typing or using a VIN barcode scanner, for example. The software user activates the “Generate Remote” button 25 to begin the remote programming process. In a preferred embodiment, this process checks whether a user wishes to duplicate a working remote or generate a new remote control on-demand. One example of such a process is described in further detail with reference to FIG. 6.

While the embodiments shown in FIGS. 1-2 show a computer connected to RCP 13 with a serial cable, other configurations are possible. For example, computer 10 code database 11, and remote control programmer 13 may all be housed in a kiosk placed, for example, in a locksmith shop or auto service center. Computer 10 may contain code database 11, or may access it remotely at a central, secure location over a wide area network (WAN) such as the Internet, for example. In yet another embodiment, the software program may also reside remotely from the RCP 13, and employ a software interface 20 accessible through an Internet browser in an application service provider scheme. Such an embodiment may have an RCP driver installed locally, or may provide control of RCP 13 with no driver. Another embodiment, a do-it-yourself kit embodiment, may provide RCP 13 functionality remotely accessible through the Internet, although this embodiment typically will not provide remote duplication functionality. Further, while a separate computer 10 and RCP 13 are shown, they may be embodied in a single device such as, for example, an integrated programming unit in the form of a counter-top terminal or portable, hand-held device.

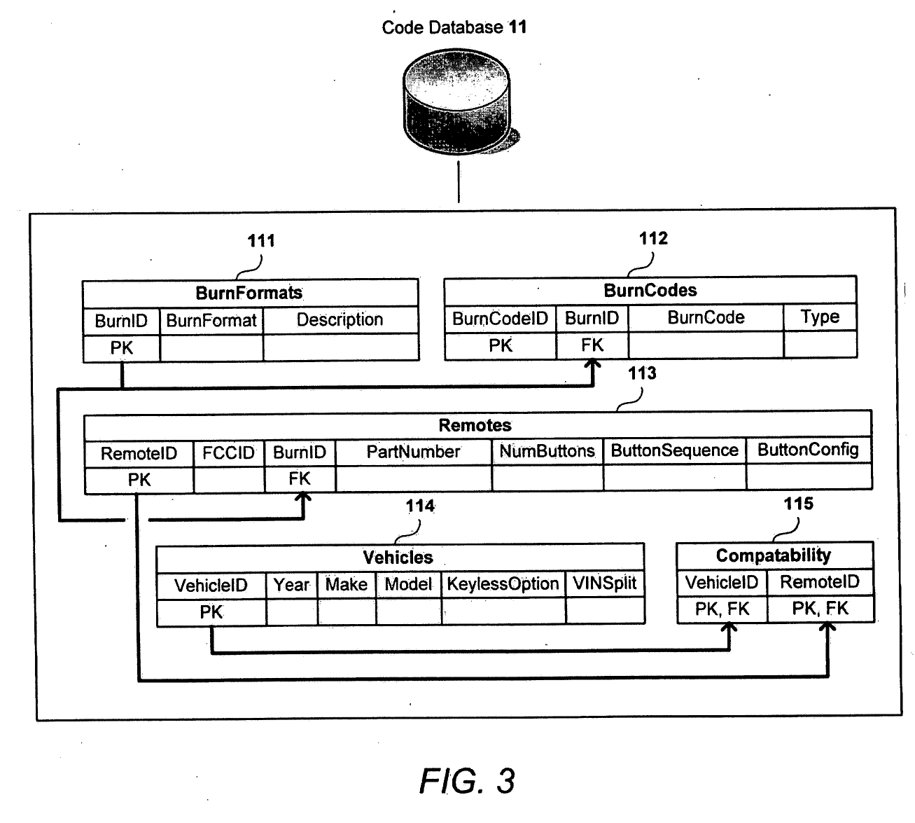

FIG. 3 shows detail of the table structure and relationships of an exemplary embodiment of code database 11 of the invention. Although code database 11 is depicted in FIG. 3 as a relational database, code database 11 may alternatively be implemented as a non-relational database, such as one or more flat files or as a collection of unlinked tables. Table BurnFormats 111 contains entries for each of the code formats employed in the invention. Each code format is uniquely identified by the primary key field of this table, BurnID. The hexadecimal representation of the code format is stored in the BurnFormat field, and the Description field stores a user-friendly description of the code format.

Table BurnCodes 112 contains entries for each individual code corresponding to each function of a particular remote control. For example, a remote control with “lock” and “unlock” buttons would have two entries in table BurnCodes 112, one for each function code. Each code is uniquely identified by the primary key field of this table, BurnCodeID. The BurnID field of this table is used as a foreign key field to table BurnFormats 111. Field BurnCode contains the hexadecimal representation of the function code, and the Type field stores a representation of the type of function associated with the code.

Table Remotes 113 contains entries for the original equipment (OE) remote controls that can be replaced by the present invention. Each remote control is uniquely identified by the primary key field of this table, RemoteID. The BurnID field of this table is used as a foreign key field to table BurnFormats 111. The FCCID field stores the identifier assigned by the Federal Communications Commission (FCC) to the OE remote control. The PartNumber field stores the part number assigned by the manufacturer of the OE remote control. The NumButtons, ButtonSequence, and ButtonConfig fields store information about the number and configuration of the buttons of the OE remote control.

Table Vehicles 114 stores identifying information about vehicles to facilitate determination of the correct replacement remote control for a given make, model, and year, or VIN, of a vehicle. Each vehicle is uniquely identified by the primary key field of this table, VehicleID. The Year, Make, and Model fields of this table store the year, make, and model, respectively, of vehicles known to the system. The KeylessOption stores identifier information for various keyless entry system options that may have been available for a particular year, make, and model, or for after-market keyless entry system modifications. The VINSplit stores the part of the VIN associated with the year, make, and model of the vehicle for that entry (excluding the serial number portion of the VIN).

Table Compatibility 115 relates the vehicles stored in table Vehicles 114 to their corresponding remote controls, stored in table Remotes 113. As shown on FIG. 3, table Compatibility 115 contains only two key fields, VehicleID and RemoteID, which combined are the primary key field of this table, and foreign keys to tables Vehicles 114 and Remotes 113.

Another table, BurnRules (not depicted in FIG. 3) may optionally be used with code database 11 of the invention to store mapping rules regarding the transmitted data from the remote control. These rules allow the software program to automatically map the transmitted signal from the source remote control (in duplication mode) to one of the six different possible buttons (e.g., unlock, lock, trunk, panic, light, and option). This function provides ease of use and increases duplication reliability since the user does not have to be instructed on which button to press as the codes are being “learned” by the system during duplication mode. The tables of exemplary code database 30 are accessed by software program 20 to identify the correct code format and codes for a particular vehicle.

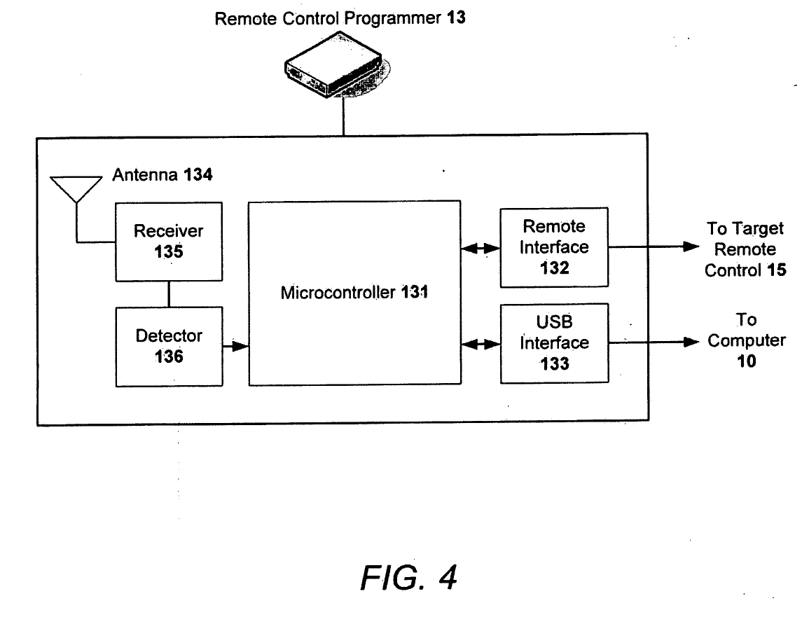

FIG. 4 shows a preferred embodiment of remote control programmer 13 of the present invention. Microcontroller 131 executes computer instructions to perform the functions of remote control programmer 13, and is preferably a microcontroller or microprocessor. Microcontroller 131 is preferably implemented with a Motorola PC116F76-I/SO microcontroller. Other microcontrollers or microprocessors may be used. The computer instructions executed by microcontroller 113 may be stored in non-volatile read-only memory (ROM) or random-access memory (RAM) that is part of microcontroller 113, or in such types of memory external to the microcontroller.

In a preferred embodiment, remote control programmer 13 communicates with target remote control 15 through its remote interface 132 via a four-wire serial connection over serial cable 14. Remote interface 132 can be implemented in software (i.e., by executing instructions in the microcontroller) or in hardware (i.e., by dedicated serial interface hardware as part of remote control programmer 13). For example, a Motorola 93LC86 serial EEPROM may be used in the hardware embodiment of remote interface 132. Remote control programmer 13 communicates with software program 20 on computer 10 through its USB interface 133 in a preferred embodiment. In one embodiment, the USB interface 133 is implemented with a Maxim 232CPE USB interface IC. USB interface 133 is used to communicate codes learned from a source remote control 16 in duplication mode to software program 20, and to receive codes from software program 20 to be written to target remote control 15 in both modes of operation.

In an alternative embodiment, remote control programmer 13 can be optionally located in a remote location, relative to target remote control 15. In this case, the remote control programmer communicates to the target remote control via one or more networks, allowing an end user to program remotes from his or her computer 10. In this embodiment, the target remote control interfaces directly with the user's computer 10 via USB or other means. This embodiment allows retailers without computers or Internet connectivity to stock and sell remote control blanks with a “do it yourself” (DIY) interface kit.

Although the preferred embodiment has been described with reference to a system that generates fixed-code remote controls, it is equally advantageous and compatible with keyless entry systems that utilize rolling codes. In an alternative embodiment, remote control programmer 13 is able to support rolling codes by writing the rolling-code pseudo-random number generating algorithm onto target remote control 15, rather than just simple fixed codes as in the preferred embodiment.

As depicted on FIG. 4, remote control programmer 13 receives RF signals from source remote control 16 over antenna 134, in the preferred embodiment. Alternatively, when remote control programmer 13 is used with infrared (IR) remote controls, an optical receiver (not shown) is used in addition to, or in lieu of, antenna 134. The received RF (or IR) signal is processed by receiver 135 and detector 136, which outputs a digital bit stream to microcontroller 113 representing the code received from source remote control 16. Preferably, a U893BSE receiver IC is used to implement the receiver 135. Detector 136 is preferably implemented with a 74HC1320 detector IC.

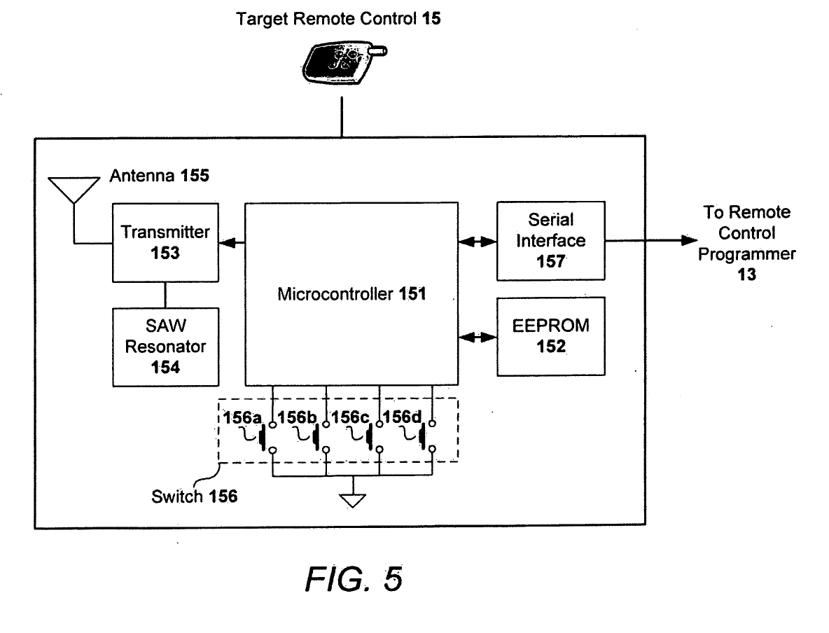

FIG. 5 shows an exemplary embodiment of target remote control 15 used with the invention. Target remote control 15, also known as a remote control “blank,” is a generic remote control that can be programmed with different code formats and codes to serve as a replacement remote control in accordance with the present invention. Target remote control 15 includes microcontroller 151, which executes computer instructions to perform the functions of remote control 15, and is preferably a microcontroller or microprocessor. The computer instructions executed by microcontroller 151 may be stored in non-volatile read-only memory (ROM) or random-access memory (RAM) that is part of microcontroller 151, or in such types of memory external to the microcontroller. In a preferred embodiment, target remote control 15 communicates with remote control programmer 13 through serial interface 157 via a four-wire serial connection over serial cable 14. Switch 156 is an array of one or more individual switches 156a-156d associated with buttons or keys on target remote control 15. For example, the “lock” function could be assigned to switch 156a, “unlock” function to switch 156b, “lights” function to switch 156c, and “panic” function to switch 156d. In a preferred embodiment, closing one of switches 156a-156d causes microcontroller 151 to retrieve the code associated with the function corresponding to the switch from electrically erasable programmable read-only memory (EEPROM) 152. The code thus retrieved by microcontroller 151 is output to transmitter 153, which, in combination with surface acoustic wave (SAW) resonator 154, modulates the binary code into its RF or IR analog representation for transmission to the receiver of the keyless entry system. In an RF remote control, the transmitter transmits the RF signal over antenna 155. In an alternative embodiment based on IR, an optical transmitter (not shown) is used in addition to, or in lieu of, antenna 155.

By way of non-limiting examples of the preferred embodiment, target remote control 15 supports commonly used frequencies 303, 315, 318 and 433 MHz, and may optionally contain a variable-frequency tuner to permit use of other frequencies. In an exemplary embodiment, microcontroller 151 is an Elan Microelectronics EM78P447SAS microcontroller, EEPROM 152 is a 93C86 serial EEPROM, SAW resonator 154 is a 315 MHz SAW resonator, and transmitter 153 is implemented using discrete components.

Although the preferred embodiment has been described with reference to a system that generates remote controls, it is equally advantageous and compatible with RF transponders, also known as RF identification (RFID), used in modem keys for vehicles and other systems. In an alternative embodiment, remote control programmer 13 is also able to read codes from an existing functioning transponder (RFID) in a key and transfer that code onto programmable key “blanks.” This embodiment entails the addition of a coil to remote control programmer 13 to energizing the transponder in the key. Once energized, remote control programmer 13 reads the codes in the same manner as it determines the remote control codes in duplication mode.

Similarly, in an alternative embodiment, remote control programmer 13 is also able to generate new RFID transponders by retrieving the transponder code through similar database schema as code database 30 for subsequent writing onto a writeable RFID key blank. In this embodiment, the interface between remote control programmer 13 and the RFID key blank is wireless.

In yet a further alternative embodiment, remote control programmer 13 is capable of programming both remote control and transponder codes onto an integrated RFID key/remote control. Although the present invention has been described with reference to the programming of a remote control or RFID key for use with one keyless entry system, it may also be advantageously used to program a remote control or RFID key for use with a plurality of keyless entry systems, such as several vehicles, or a vehicle and a garage door opener.

FIG. 6 shows a flow chart of a method of generating a replacement remote control according to one embodiment of the present invention. In step 160, customer information is entered. The customer information may include, for example, information needed to identify the customer's vehicle if a vehicle key is being duplicated. For example, the year, make, model, receiver type, and vehicle identification number (VIN) may be entered. Other unique serial numbers that may identify the customer vehicle or remote may also be entered, such as, for example, the Federal Communications Commission (FCC) identifier for the customers original remote control.

In step 161, the operator inputs whether the customer has a working source remote control 16 from which the target remote control 15 is to be duplicated. If not, the method proceeds to step the on-demand programming procedure beginning at step 162, which retrieves a new bum code from code database 11 using the identifier information previously provided. Next, step 163 transfers the retrieved bum code to target remote control 15. Preferably, steps 162 and 163 are used to transfer all required codes to target remote control 15. In step 164, the vehicle is programmed to learn the new bum codes. The on-demand programming procedures then ends at step 165.

If the customer possesses a working source remote control 16, the depicted method proceeds from step 161 to step 166, where RCP 13 retrieves existing bum code(s) from the customer's working remote, preferably using RF detection or a serial interface. Code database 11 is used to retrieve the right “type” of code for compatibility with the keyless entry receiver. Code database 11 preferably uses year, make and model as the primary input for selecting code type. By employing such pre-selected code type, the remote function response time of the target remote control 15 that of the original source remote control 16. The code is formatted with the proper type and is transferred to the blank target remote control 15 in step 167. This duplication procedure typically requires no programming of the vehicle, and the remote is ready to operate the keyless entry system at step 168.

A number of embodiments of the invention have been described. Nevertheless, it will be understood that various modifications may be made without departing from the spirit and scope of the invention. For example, a do it yourself (DIY) programming kit has been described, as well as a application service provider interface. Accordingly, other embodiments are within the scope of the following claims.

What is claimed is:

1. A system for providing replacement remote controls, the system comprising:
a computer;
a database storing at least remote control code formats for selected vehicle types;
a remote control programmer coupled to the computer, the remote control programmer having an interface adapted for connection to a target remote control;
a software program installed on the computer and being communicatively coupled with the database, the software program comprising instructions for querying the database and instructions for controlling the remote control programmer.

2. The system of claim 1 in which the computer and the remote control programmer are housed in a kiosk.

3. The system of claim 1 further comprising a vehicle identification number bar code scanner operably coupled to the computer.

4. The system of claim 1 in which the database is installed on the computer.

5. The system of claim 4 in which the database further stores remote control codes.

6. The system of claim 5 in which the database is a relational database and the remote control codes are relationally accessed using identifiers for the remote control code formats.

7. The system of claim 1 in which the remote control programmer further comprises a wireless transceiver for programming a target remote control.

8. A method of providing programmed remote controls, the method comprising the steps:
receiving, with a software program, a first one or more identifiers sufficient to identify a desired programming code;
querying a database to obtain the desired programming code;
programming a target remote control with the desired programming code formatted according to a desired programming code type.

9. The method of claim 8 in which the first one or more identifiers comprise a code from an existing remote control.

10. The method of claim 8 in which the first one or more identifiers comprise a vehicle identification number (VIN).

11. The method of claim 8 further comprising the step of receiving a second one or more identifiers sufficient to identify the desired programming code type.

12. The method of claim 11 in which the second one or more identifiers further comprise a selected code type of the existing remote control.

13. The method of claim 11 in which the second identifier further comprises vehicle make and model information.

14. The method of claim 11 in which the second identifier comprises a vehicle identification number (VIN).

15. A method for providing programmed replacement remote controls, the method comprising the steps:
receiving, with a software program, a vehicle identification number (VIN);
querying a database, the query containing at least an indication of the VIN;
receiving, from the database, an indication of a code and an indication of a code format;
transmitting, from the software program, the indication of the code and the indication of the code format to a remote control programmer;
initiating a programming sequence on the remote control programmer, the programming sequence programming the code, formatted according to the code format, into a target remote control coupled to the remote control programmer.

16. The method of claim 15 in which the target remote control is coupled to the remote control programmer over a network.

17. The method of claim 15 further comprising the steps:
receiving an indication of a pseudo-random number generating algorithm;
programming the pseudo-random number generating algorithm into the target remote control.

18. The method of claim 15 in which the step of receiving a VIN is accomplished by scanning a VIN bar code with a barcode scanner connected to a computer on which the software program is operating.

19. The method of claim 15 in which the step of receiving a VIN is accomplished by typing the VIN onto a computer on which the software program is operating.

20. The method of claim 15 in which the database is a relational database, the indication of the code format being accessible by a remote control ID, wherein the remote control ID is determinable by the VIN.
